(19) United States
(12) Patent Application Publication
(10) Pub. No.: US 2026/0238666 A1
(43) Pub. Date: Aug. 13, 2026

(54) SMART INFRASTRUCTURE CONTROL SYSTEMS (SICS) SECURITY MONITORING AND DEFENSE

(71) Applicant: Landis+Gyr Technology, Inc., Alpharetta, GA (US)

(72) Inventor: Todd WIEDMAN, Alpharetta, GA (US)

(21) Appl. No.: 19/471,511

(22) PCT Filed: Apr. 4, 2024
(86) PCT No.: PCT/US2024/022965

§ 371 Date: Oct. 1, 2025

Related U.S. Application Data
(60) Provisional application No. 63/496,530, filed on Apr. 17, 2023.

(51) Int. Cl. H04L 9/40; H04L 41/069

(52) U.S. Cl. CPC H04L 63/1425; H04L 41/069

(57) ABSTRACT

The control application generates log files that provide information about the management of the plurality of devices it is responsible for. The information in the log files is dependent upon the messages received from the devices or the commands issued to the devices. For example, in the case of smart meters, the log files generated comprise meter readings, firmware changes, firmware updates, indications as to whether or not the meter has been opened up, indications of overheating at the meter. A software agent extracts information from the log files that may be analysed to determine any anomalies that may be associated with an attack on the system. The analysis performed may comprise pattern matching against the information obtained from the log files, performing an AI analysis of the information obtained from the log files, identifying a signature, etc.

### TECHNICAL FIELD

The present disclosure relates to a computer system comprising at least one processor and at least one memory, and in particular to a computer system for providing a control application for controlling a plurality devices accessible over a network.

### BACKGROUND

Certain devices are subject to centralised control by a computer system providing a control application. The control application exercises control over a plurality of devices both by receiving messages from the devices, and issuing commands to control the operation of the devices. As an example, a type of device subject to centralised control is a smart meter, which monitors information such as the consumption of electricity and/or gas, and reports this information to a computer system to enable energy providers to monitor consumption and bill consumers. There may a large number of smart meters (e.g. millions), which provide data over a network to a centralised computer system.

Increasingly, smart meters not only provide reports of energy consumption, but also receive commands from a control application, such as a disconnect command, which causes the power to be turned off throughout the property associated with the smart meter.

Given that a centralised control system is responsible for a large number of smart meters, this opens up the possibility for a threat actor (i.e. a cyber attacker) to cause harm on a significant scale by attacking the centralised control system. For example, if a cyber-attacker is able to gain control of the centralised control system, that attacker may be capable of causing the system to issue disconnect commands to a large number of smart meters, causing significant disruption to the supply of power.

### SUMMARY

It is desirable to reduce the threat posed by an attack on a centralised control system. According to a first aspect, there is provided a computer system comprising at least one processor and at least one memory, the at least one memory storing computer readable instructions, one or more log files, and a set of conditions, the at least one processor being configured to execute the instructions to: provide a control application configured to exchange messages over at least one network, the messages including commands to a plurality of devices to control the plurality of devices; generate and store log data for the control application in the one or more log files held in the at least one memory, where the log data is generated in dependence upon the messages exchanged over the at least one network by the control application; provide a software agent configured to extract a set of information from the at least one memory, the set of information including a subset of the log data from the one or more log files; provide an analytics engine configured to analyse the extracted subset of the log data to determine whether any of the conditions are met; and in response to determining that one of the conditions is met, cause an action to be performed to notify a user.

The control application generates log files that provide information about the management of the plurality of devices it is responsible for. The information in the log files is dependent upon the messages received from the devices or the commands issued to the devices. For example, in the case of smart meters, the log files generated comprise meter readings, firmware changes, firmware updates, indications as to whether or not the meter has been opened up, indications of overheating at the meter. A software agent extracts data from the log files (and additionally may extract configuration data) that may be analysed to determine any anomalies that may be associated with an attack on the system. The analysis performed may comprise pattern matching against the information obtained from the log files, performing an AI analysis of the information obtained from the log files, identifying a signature in the log data, etc.

According to a second aspect, there is provided a computer implemented method comprising: providing a control application configured to exchange messages over at least one network, the messages including commands to a plurality of devices to control the plurality of devices; generating and storing log data for the control application in one or more log files held in at least one memory, where the log data is generated in dependence upon the messages exchanged over the at least one network by the control application; extracting a set of information from the at least one memory, the set of information including a subset of the log data from the one or more log files; analysing the extracted subset of the log data to determine whether any of a set of conditions are met; and in response to determining that one of the conditions is met, causing an action to be performed to notify a user.

In some embodiments, the set of information further comprises configuration data extracted from a configuration file stored in the at least one memory, wherein the method comprises determining whether any of the set of conditions are met by analysing the configuration data.

In some embodiments, comprising determining that the one of the conditions is met in response to identifying a pattern or signature in the extracted subset of the log data and the configuration data.

In some embodiments, the step of analysing the extracted subset of the log data comprises: in dependence upon the extracted subset of the log data, providing a plurality of input values to one or more machine learning modes configured to obtain an output; and comparing the output to a threshold indicated by the one of the conditions to determine that the one of the conditions is met.

In some embodiments, the method comprises generating from the extracted subset of the log data, the plurality of input values.

In some embodiments, the set of information further comprises configuration data extracted from a configuration file stored in the at least one memory, wherein the method comprises: determining whether any of the set of conditions are met by analysing the configuration data, in dependence upon the configuration data, providing a plurality of further input values to the one or more machine learning modes configured to obtain the output.

In some embodiments, the one or more machine learning models comprise a neural network configured to receive the input values.

In some embodiments, the step of analysing the extracted subset of the log data comprises: identifying a pattern or signature in the extracted subset of the log data specified by the one of the set of conditions to determine that the one of the conditions is met.

In some embodiments, the action comprises controlling the user interface to display statistical information relating to the at least one condition.

In some embodiments, the plurality of devices comprises a plurality of smart meters, wherein the step of providing the control application is performed by a head end system. In some embodiments, the action comprises generating an alert.

In some embodiments, the computer system comprising a first computing device and a second computing device, wherein: the first computing device comprises a first processor of the at least one processor, the first processor being configured to execute a first set of the computer readable instructions to: provide the control application and the software agent; and cause the extracted set of the information to be sent over the at least one network to the second computing device; and the second computing device comprises a second processor of the at least one processor configured to execute a second set of the computer readable instructions to provide the analytics engine.

According to a third aspect, there is provided a computer program comprising computer readable instructions, which when executed by at least one processor cause a method according to the second aspect or any embodiment thereof to be performed.

According to a fourth aspect there is provided, a non-transitory computer readable medium storing a computer program comprising computer readable instructions, which when executed by at least one processor cause a method according to the second aspect or any embodiment thereof to be performed.

### BRIEF DESCRIPTION OF DRAWINGS

Arrangements of the present invention will be understood and appreciated more fully from the following detailed description, made by way of example only and taken in conjunction with drawings in which:

FIG. 1 illustrates an example of a computer system comprising at least one processor and at least one memory;

FIG. 2 illustrates an example of a computer system comprising at least one processor and at least one memory;

FIG. 3 illustrates an example of a computer system comprising a plurality of devices connected to a smart infrastructure control system;

FIG. 4 illustrates an example of a smart infrastructure control system and a security monitoring and defense system in communication with one another;

FIG. 5 illustrates an example of a computer system providing both a control application and analytics engine;

FIG. 6 illustrates a simplified example of a neural network;

FIG. 7 illustrates an example of a process for deriving outputs from a neural network based on log entries, where the outputs are indicative of events that have occurred in the system;

FIG. 8 illustrates an example of a process for training a machine learning model to derive outputs that are indicative of events that have occurred in the system;

FIG. 9 illustrates an example of different event types and the actions that may be performed in response to detecting the respective type of event; and

FIG. 10 illustrates an example method according to embodiments.

### DETAILED DESCRIPTION

Embodiments of the application are implemented in a computer system, which may comprise a single device or multiple devices that communicate with each other over a network.

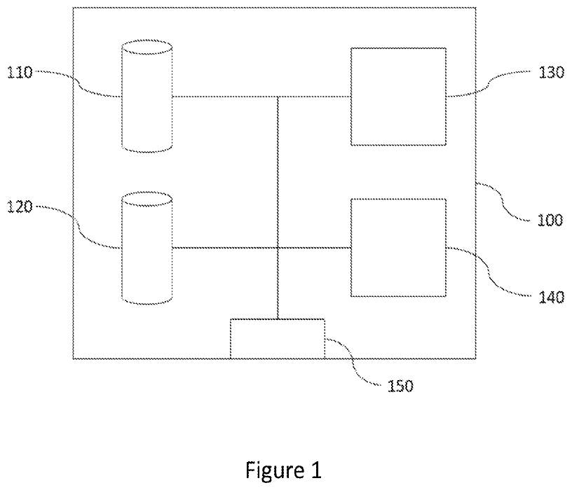

Reference is made to FIG. 1, which illustrates an example computer system 100 that may provide a control application for controlling a plurality of devices, such as smart meters. The system 100 may comprise a server, back-end system, or the like. The system 100 may also be referred to as a computing device 100.

The system 100 comprises at least one memory 110, 120, at least one data processing unit 130, 140 and an input/output interface 150. The at least one memory 110, 120 comprises a random access memory 110 and at least one hard drive 120. The memories 110, 120 store computer executable code which, when executed by at least one data processing unit 130, 140, perform the steps described as being performed by the system 100. The memories 110, 120 may be used for storing data associated the control application. In particular, the memories 110, 120 may be used for storing a log file comprising data logged by the control application.

The at least one processor 130, 140 communicates with the memories 110, 120 to load instructions for execution, load data for processing, and store the results of processing that data. At the interface 150, the system 100 sends and receives messages. The messages received at the interface 150 comprise data for processing by the at least one processor 130, 140. The messages sent from the interface 150 are created by the at least one processor 130, 140.

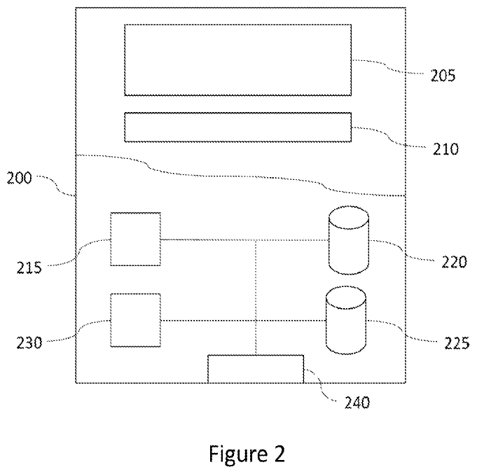

In addition to the server type system 100 that provides the control application, a further computer system may be provided for performing analysis of log data received from system 100 to determine whether one or more conditions are met. Reference is made to FIG. 2, which illustrates an example of such a further system 200, which may take the form of a user device 200. The device 200 may be a mobile user equipment (UE), a personal computer (PC), a terminal or workstation, a server, or some other form of device.

The device 200 comprises an interface 240 over which it sends and receive signals. The interface 240 may be a wired or wireless interface. For instance, the interface 240 may comprise a wired interface for connection to a wired network (e.g. a local area network and/or the internet). Alternatively or in addition, the interface 240 may comprise transceiver apparatus configured to send and receive communications over a radio interface. The transceiver apparatus may be provided, for example, by means of a radio part and associated antenna arrangement. The antenna arrangement may be arranged internally or externally to the system 200.

The system 200 is provided with at least one data processing entity 215, at least one random access memory 220, at least one read only memory 225, and other possible components 230 for use in software and hardware aided execution of tasks it is designed to perform, including control of, access to, and communications with access systems and other communication devices. The at least one random access memory 220 and the hard drive 225 are in communication with the data processing entity 215, which may be a data processor. The data processing, storage and other relevant control apparatus can be provided on an appropriate circuit board and/or in chipsets. A user controls the operation of the system 200 by means of a suitable user interface such as key pad 210, or by voice commands. A display 205 is included on the system 200 for displaying visual content to a user. The system 200 may also comprise a speaker for providing audio content.

The memory of the system 200 (i.e. the random access memory 220 and the hard drive 225) is configured to store computer readable instructions for execution by the data processor 215 to perform the data processing functions described herein as being performed by the system 200.

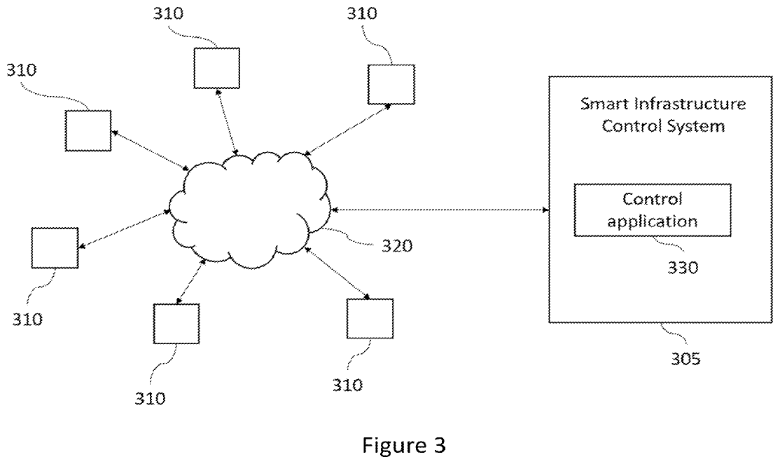

Reference made to FIG. 3, which illustrates a system 300 comprising the computer system 305 and a plurality of devices 310 that operate under the control of the system 305. The system 305 may be referred to as a smart infrastructure control system (SICS) 305. The system 305 may be provided by the example system 100 shown in FIG. 1. Any operations referred to herein as being performed by system 305 are understood to refer to operations performed by at least one processor of the system 305 executing computer readable instructions to perform the operations referred to herein as being by system 305.

Each of the plurality of devices 310 comprises at least one processor for executing a set of software stored in memory of the respective device to carry out a specific set of operations. Each of the devices 310 exchanges messages over the network 320 with a control application 330 running on the system 305. Such messages include status reports provided by the devices 310 to the control application 330, and commands provided by the control application 330 to control the operation of the devices 310.

Each of the devices 310 may comprise a smart meter for monitoring energy (e.g. electricity) usage. To this end, each smart meter 310 sends messages to the system 305 over the network 320, where those messages comprise meter readings. In response to receipt of these messages at the system 305, the control application 330 causes the meter readings to be logged in a log file. Each of the smart meters 310 is also responsive to commands issued by the control application 330. Such commands include a disconnect command, which causes the smart meter 310 to disconnect the electricity supply to its associated property.

In addition to exchanging messages with the devices 310, the system 305 may exchange further messages with one or more remote systems (either over the same network 310 or a further network). These further messages may be exchanged over the internet and could, for example, include requests for remote login to the system 305 to enable a user to send information to the control application 330 and receive information from the control application 330. Exposure of the system 305 to internet traffic increases the possibility that a threat actor may access the system 305 remotely, and engage in one or more attacks against the devices 310. For example, a threat actor could send malicious firmware to the system 305 and cause the control application 330 to send this malicious firmware to the devices 310 for installation. The threat actor could remotely login to the system 305 to cause the control application 330 to send control messages (e.g. disconnect commands) to a number of the devices 310.

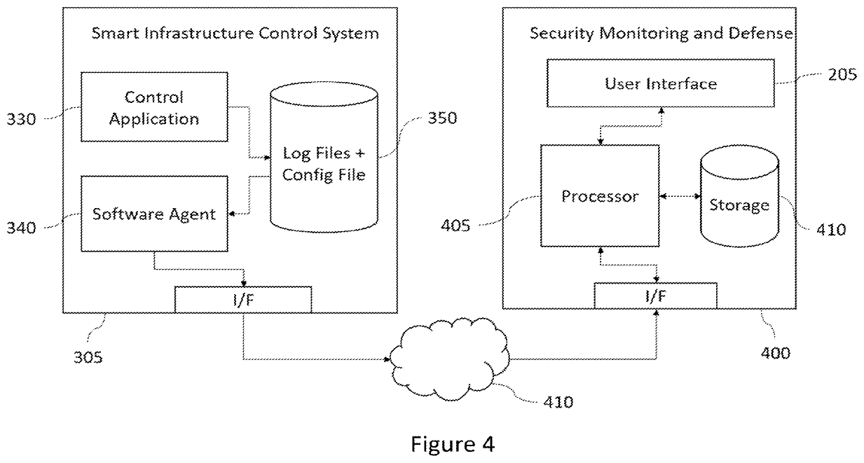

Reference is made to FIG. 4, which illustrates a further view of the smart infrastructure control system 305 in communication with a further system 400. The further system 400 may be referred to as a Security Monitoring and Defense (S.M.A.D.) system 400. The two systems 305, 400 communicate with one another over the network 410. The network 410 may be the same or different to the network 320.

As discussed, the system 305 supports a control application 330, which outputs one or more log files for storage in memory 350 of the system 305. The log files comprise log entries providing details of events associated with the control application 330 that have occurred. Each log entry comprises a timestamp indicating the date and time of the event, a description of the event, and may include an indication of the device 310 with which the event is associated. Additional details can be included in the log files based on the type of devices 310 being controlled.

As an example, one type of event for which a log entry is generated is a status indication that is received in a report packet from one of the devices 310. Such a status indication could, for example, be a meter reading or an indication of power usage levels in the case that the devices 310 are smart meters. The status indication could be an indication of heat level at the device 310. The status indication could be an indication of a physical change at the device 310, e.g. has a door of the device 310 been opened. The status indication could be an indication of remaining charge level if the devices 310 are battery packs. The status indication is received at the system 305 in a message from one of the devices 310 and, in response, the control application 330 generates a log entry comprising the status indication, a time stamp associated with status indication, and an indication of the device 310 from which the status indication was received.

A further example of a type of event for which a log entry is generated is an update to firmware on the devices 310. Such a firmware update is provided by the control application 330 in messages sent to one or more of the devices 310 to cause the firmware running on those devices 310 to be updated. In addition to providing the firmware update, the control application 330 causes one or more log entries to be generated in relation to the firmware update, where those log entries provide details of the firmware update, a timestamp associated with the firmware update, and the devices 310 on which the firmware update has been provided.

A further example of a type of event for which a log entry is generated is a command generated by the control application 330 and sent from the system 305 to one or more of the devices 310. The command could be a command to activate or deactivate the device 310, change the mode of operation of the devices 310 or perform some other action. In addition to generating and sending the command, the control application 330 causes a log file to be generated in relation to the command. Such a log file may comprise an indication of the type of command sent (e.g. a terminate command), along with an indication of the device 310 to which this command was sent.

A further example of a type of event for which a log entry is generated is the generation and sending of a command by the system 305 in dependence upon configuration changes (e.g. a password reset) being made to the system 305. These configuration changes cause a log file to be generated, where the log file comprises details of the change.

As shown in FIG. 4, in addition to the control application 330, a software agent 340 runs on the system 305. The software agent 340 accesses the memory 350 to retrieve a subset of the logged information from the memory 350. The software agent 340 is programmed to retrieve the information from the memory 350 that is useful for analysis to determine the occurrence of certain events in the activity across the system 300. Such events include anomalies that are indicative of security threats that may have taken place in the system 300. The retrieved information is dispatched over the interface of the system 305 and over the network 410 and is received at the system 400. The information extracted from the log files by the software agent 340 and sent over the network 410 may comprise a plurality of log entries from the log files, or may comprise information extracted from one or more entries of the log files. In either case, the information extracted from the log files is referred to herein as the log data.

In addition to storing the log files, memory 350 of the system 305 also stores a configuration file. The configuration file comprises configuration data for the system 305 and may also include configuration data for the devices 310. The configuration data includes information such as passwords for the system 305 (e.g. enabling remote access over the network 320), an IP address of the system 305, a reporting frequency (e.g. of meter reading reports) of the devices 310. The software agent 340 also dispatches over the network 410 to the system 400, configuration data extracted from the configuration file.

A processor 405 is configured to execute instructions to provide an analytics engine that is configured to perform processing of the log data in order to determine whether or not the content of the logs satisfies one or more conditions that indicate one or more events that have taken place. The processing may comprise performing pattern matching in accordance with a set of rules stored in the storage 410 in order to identify whether there are any patterns in the log data that indicate a particular event. The patterns that the processor 405 analyses the log data to identify include patterns that have been recorded previously that were found to be malicious in nature or seen as part of a previous attack. The processing may comprise analysing the log data to identify whether one or more signatures are present in the log data. The processing may comprise applying one or more machine learning models to the log data or data derived from the log data in order to identify whether there are any patterns in the data that are indicative of a particular event. In this case, the analytics engine obtains from the machine learning model an output value and compares this output value to a threshold to determine whether an event has taken place.

The analytics engine may determine whether or not the conditions are met also based on analysis of the configuration data in addition to the analysis of the log data. The analysis of the configuration data may also comprise performing pattern matching in accordance with rules stored in the storage 410 in order to identify whether there are patterns in the configuration data or the log data that indicate a particular event. The processing may comprise analysing the configuration data to identify whether one or more signatures are present in the configuration data. The processing may comprise applying one or more machine learning models to input values derived from the log entries and the configuration data in order to identify whether there are any patterns in the data that are indicative of a particular event.

As an example, one type of event that the analytics engine 500 may be configured to detect is a replay attack. The storage 410 may comprise a set of rules indicating one or more conditions that may be met by logged data and that are indicative of a potential replay attack. The log data retrieved by the software agent 340 and provided to the system 400 may include timestamps derived from packets received at the system 305, where these timestamps indicate the time at which the packet was created. Such timestamps are stored as part of the log files in storage 350. The log data retrieved by software agent 340 may also include timestamps indicating the time of receipt of the packets at the system 305 from over the network 410, where the system 305 generates those time stamps and stores them as part of the log files in storage 350. The analytics engine receives from the software agent 340, the one or more timestamps indicating the time at which packets are sent, and the one or more timestamps indicating when the packets were received at the system 305. The storage 410 stores a rule defining a condition that a potential replay attack is detected if the differences between the two timestamps for one or more packets exceeds a given amount. The condition may be defined in relation to a single packet (i.e. the timestamp difference must exceed the predefined amount for at least one packet in order for the condition to be met) or may be defined in relation to multiple packet (i.e. the timestamp difference must exceed the predefined amount for each of multiple packets in order for the condition to be met). For each packet for which it receives a pair of timestamps (i.e. the timestamp of packet creation of the timestamp of packet receipt), the analytics engine compares the associated pair of timestamps and, in response to determining that the difference between the timestamps exceeds a predefined amount, determines that the condition for a potential replay attack is met. In response, the processor 405 may cause this to be flagged to the user.

As a further example, the analytics engine may detect a replay attack based on packet checksums. The system 330 may cause checksums of packets received over the network 320 to be logged in a log file in storage 350. The software engine 340 extracts these checksums as part of the log data and sends them over the network 410 to the system 400. The analytics engine may, in accordance with one or more conditions defined by rules held in storage 410, analyse the checksums to identify patterns in the checksums. For example, if a number of the checksums match, this may be indicative of a replay attack resulting in multiple instances of the same packet being transmitted to the system 305. In response to determining that such a condition is met, the processor 405 may cause this to be flagged to the user.

As noted, the analytics engine may identify events on the basis of the configuration data, in addition to the log data. As an example, the analytics engine may receive from the software agent 340 as part of the configuration data, an indication of reporting frequency for the devices 310. The analytics engine also receives from the software agent 340, log data indicating packet arrival times (i.e. timestamps) of reports received from the devices 310 and the IP addresses of those devices 310 from which the report packets were sent. The storage 410 stores rules identifying a condition to be met by the report frequency and the packet arrival times. The condition may be that the pattern of packet arrival times and IP addresses is indicative of a reporting frequency that does not match the reporting frequency derived from the configuration data. The analytics engine analyses the packet arrival times and the IP addresses received from the software agent 340 to determine a reporting frequency, and compares this determined reporting frequency to the reporting frequency in the received configuration data. In response to determining a mismatch, the analytics engine performs an action to notify a user.

As a further example, the analytics engine may detect a mis-configuration based on information describing a predefined configuration that is defined and stored in storage 410. In this case, the analytics engine receives configuration data from the software agent 340 and compares it to the configuration information stored in storage 410 to determine any deviations from the configuration described by the configuration information. In response to determining a mismatch between the configuration of system 300 (as defined by the configuration data received from the software agent) and the predefined configuration (defined by the configuration information held in storage 410), the processor 405 performs an action to notify a user.

In addition to the examples given above as to how the log data and, optionally, the configuration data may be analysed by the analytics engine, numerous other type of analysis may be carried out on different types of log and/or configuration data to determine whether conditions are met that are indicative of different types of event.

In the case that one or more machine learning models are used, these machine learning models may comprise one or more neural networks.

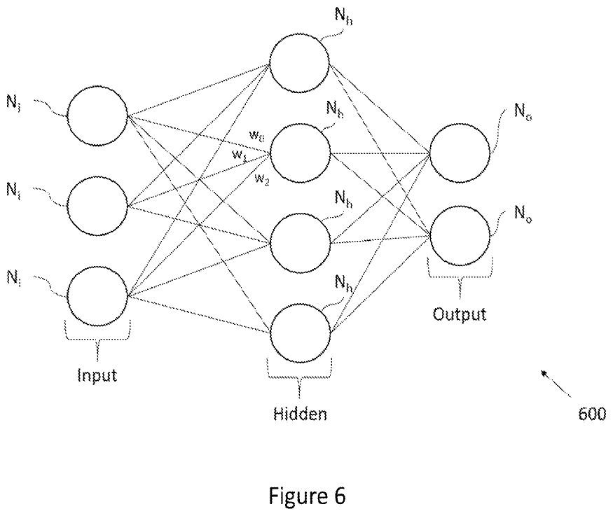

FIG. 6 shows a simplified version of a neural network 600. The neural network 600 comprises an input layer of nodes, a hidden layer of nodes, and an output layer of nodes.

In practice, there are likely to be many more nodes than those shown, and more hidden layers than the one shown. Each node of the input layer Nᵢ receives a single value of the input data and produces at its output an activation or node value, which is generated by carrying out an activation function (e.g. a sigmoid) on its input value. Each node Nᵢ in the input layer is connected to each node Nₕ in the hidden layer. A vector of node values from the input layer is scaled by a vector of respective weights at the input of each node in the hidden layer, each weight defining the connectivity of that particular node with its connected node in the hidden layer. The weights applied at the inputs of one of the nodes Nₕ are shown in FIG. 6 as w₀ . . . w₃. At each node Nₕ in the hidden layer, the input value at that node is given by the dot product of the weights vector connecting it to the input layer and the output values of the input nodes. The activation function is then applied to the input values at the nodes Nₕ to provide the output values of those nodes. The output vector of the hidden layer is supplied to each of the nodes in the next layer of the network (i.e. the nodes N_{O} of the output layer N_{O} in this case) and used in a similar manner to generate the output values for that next layer.

The network 600 may be trained through a variety of different methods, such as supervised or unsupervised learning. In one embodiment, the network 600 is trained through supervised leaning by determining at least one set of output values, comparing the output values to known labels representing ground truth values, and calculating an error or loss associated with the network 600 (e.g. based on a difference between the output values and the ground truth values). The loss is then back-propagated through the network 600 to update the weights, such that the network 600 is adapted to better approximate the labels from the input values. The update may optimize the weights according to an objective function (e.g. adjust the weights to reduce an error in the output values). In the next cycle, the updated weights are used with further training data to further revise the weights. In this way, the network can be trained to perform its desired operation.

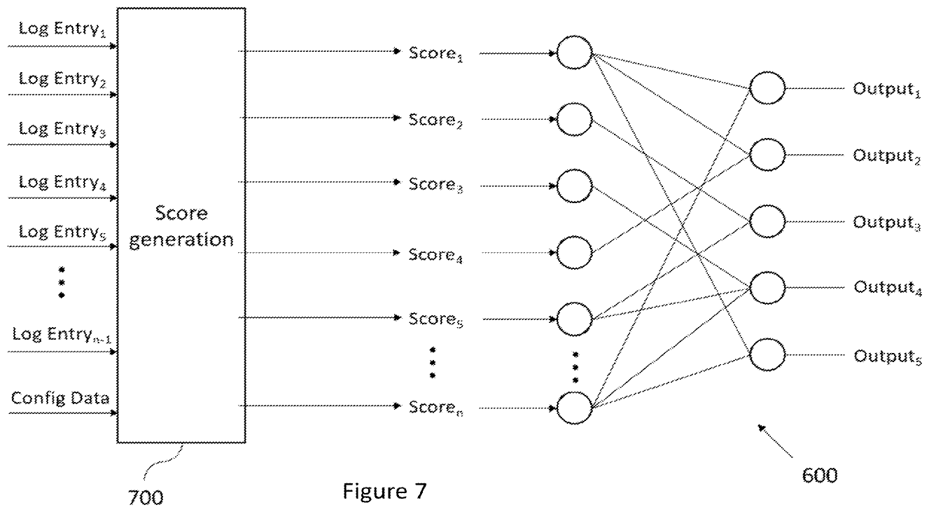

Reference is made to FIG. 7, which illustrates how the analytics engine provided by processor 405 may perform processing of log data and (optionally) configuration data in order to obtain an indication that one or more events has occurred. FIG. 7 illustrates a number of items of data shown as Log entry-to Log Entryₙ₋₁. Each of these items of data may comprise a log entry or a subset of the data from a log entry. FIG. 7 also illustrates an item of configuration data that is provided by the software agent 340. The processor 405 performs processing (illustrated by the score generation processing block 700) that processes the items (i.e. log data and configuration data) to derive a set of scores that are suitable to be provided as inputs to the first layer of the neural network 600. A score may, for example, represent a date and time at which a user logged in to the system. The score may represent a frequency with which a user logged into the system. A score may indicate whether or not an event of a particular type has been logged within a predefined time period. Although in FIG. 7, n scores are derived from n-1 log entries and one configuration file, the correspondence need not be one to one and in some embodiments, there may be more scores than the number of input items (i.e. log entries and configuration data) from which those scores derived, and in other embodiments, there may be more input items than the number of scores that are derived from those input items.

Once the scores have been derived, the processor 405 provides these scores as inputs to a neural network 600. The neural network 600 derives from these scores, a set of one or more output values (shown as output₁ to output₅), each of which provides an indication of whether an event of a particular type has occurred. Each of the output values may be compared to a respective predefined threshold value by the analytics engine to make a determination as to whether the event of a particular type has occurred. For example, Output₁ may provide an indication of whether a replay attack has occurred in the system 300. The at least one processor 405 compares Output₁ to a threshold value (e.g. 0.5) and causes an action (e.g. raising an alert) to be performed in response to determining that the value of Output₁ exceeds the threshold value.

In order to apply a machine learning model, such as neural network 600, to derive indications of anomalies or events that have taken place, such a machine learning model is first trained based on a set of input values derived from log entries along with a set of labels. The labels are indications of events that have been determined to take place in the system 300.

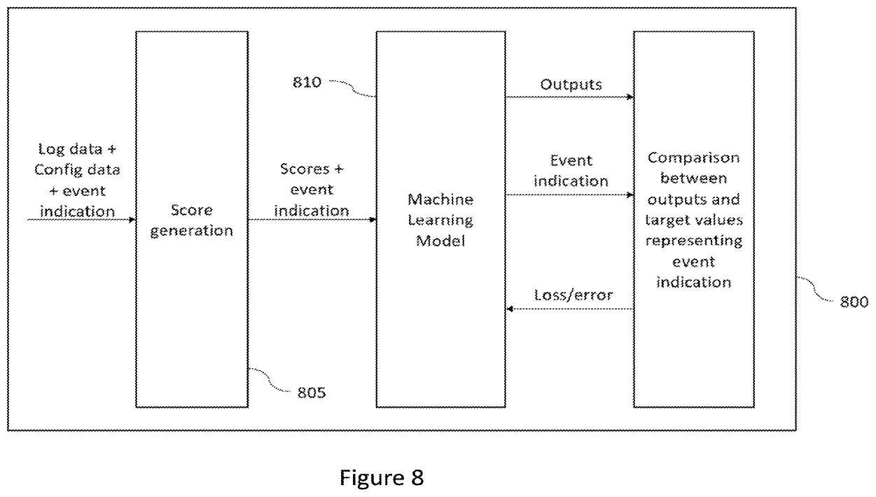

Reference is made to FIG. 8, which illustrates a system 800 in which a machine learning model 810 is trained based on log data and event indications. The system 800 may be provided according to either of the systems 100, 200.

As shown, a set of log data, configuration data, and with an indication of an event that occurred are provided to the score generation module 805. The set of log data is derived from data collected by the smart infrastructure control system 305 during operation at a time when the event occurred. For example, it may be determined after the incident that a particular attack (e.g. a replay attack or spoofing) occurred at a given point in time. The event indication is an indication of the occurrence of this attack. The log data associated with the event indication represents data stored by the control application 330 in the log files 350 during a time period during which the event occurred. Similarly, the configuration data associated with the event indication represents the configuration data during that time period. Based on this data, the machine learning model 810 may be trained to generate an indication of the event based on the log data collected during the time period and the configuration data during the time period.

As shown in FIG. 8, the log data collected by the system 305 and the configuration data is provided by the system 800 to the score generation module 805, which generates based on this log data, a set of scores suitable for input to the machine learning model 810. The score generation module 805 may also generate these scores based upon the configuration data received from the software agent 340. The machine learning model 810 may be a neural network 600, as shown in FIG. 7 or may be a different type of model. The score generation module 805 may be the same as the score generation module 700 in the case that the model 810 is a neural network 600. Once the scores have been generated, the system 800 provides the scores as inputs to the machine learning model 810, which provides a set of one or more output values in dependence upon these inputs. The system 800 then performs a comparison between the one or more outputs values and a set of one or more target values (i.e. labels), where the set of one or more target values comprise the indication of the event. By comparing the outputs and the target values, the system 800 generates a loss or error, which is applied to update the machine learning model 810. For example, if the machine learning model 810 is a neural network 600, the system 800 applies the loss to the neural network 600 to perform back propagation through the neural network 600 to obtain updates to weights of the neural network 600. The system 800 then applies those updates to update the weights of the neural network 600. The system 800 performs a number of training iterations in this way to update the weights of the neural network 600.

Referring back to FIG. 4, by performing one or more of examining log data, pattern matching against log data, identification of a signature in the log data, or applying one or more machine learning models to scores derived from the log entries, the processor 405 is configured to identify events that have occurred in the system 300. The processor 405 causes an action to be performed in response to identification of the events. The action may be the raising of an alarm. The action may comprise displaying information on the user interface 205 in relation to the event. The information in relation to the event may comprise statistical information derived by the analytics engine when performing analysis of the log data. The action may comprise sending a message, e.g. a text message or email, to a further device (e.g. a device belonging to a user that is responsible for the system 305).

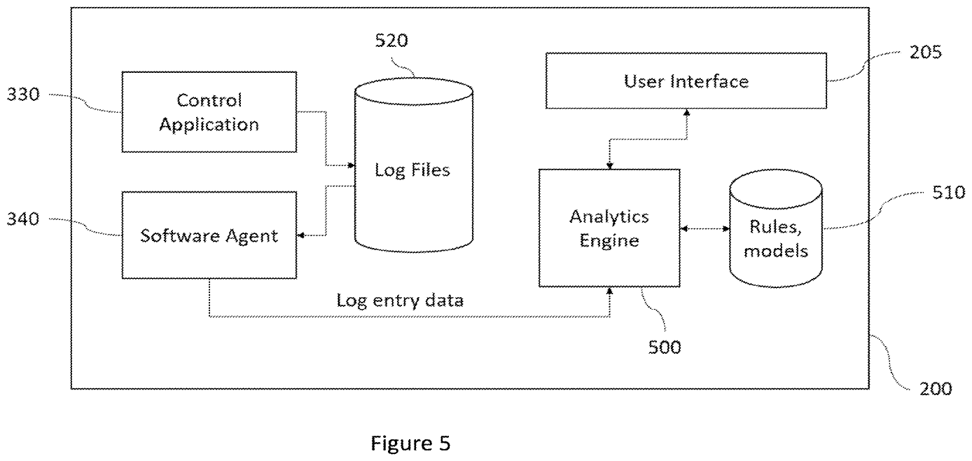

In FIG. 4, the control application 330 and analytics engine are provided by separate systems 305, 400. However, in some embodiments, the functionality may be provided by a single system. Reference is made to FIG. 5, which illustrates an example in which at least one processor of system 200 executes computer readable instructions to provide the control application 330, software agent 340, and the analytics engine 500. The analytics engine 500 performs the same operations as the analytics engine provided by the at least one processor 405 of the device 400. As discussed, the analytics engine 500 performs these operations in accordance with one or more rules or machine learning models 510. The output of the analytics engine 500 controls the user interface 205 to display information to the user relating to the identified events.

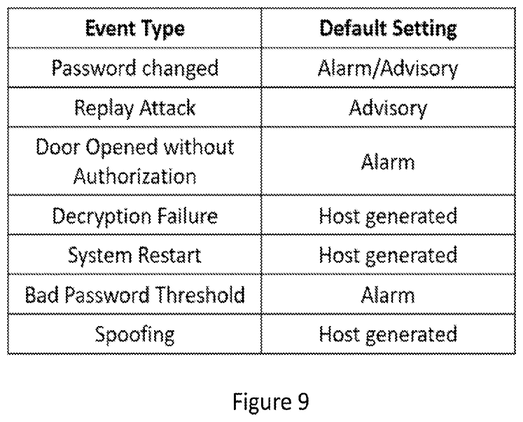

Reference is made to FIG. 9, which lists examples of certain types of event that may be detected in dependence upon the log data. One of the examples given is a password change, where that password is a password used to remotely login to the smart infrastructure control system 305. The control application 330 may generate a log entry recording the password change and store this as part of one of the log files 350 in response to receipt of an authenticated message from over the network requesting the password change. The software agent 340 is configured to provide any log entries recording password changes to the analytics engine, which detects a password change in response to receipt of such a log entry. In response, the at least one processor 405 may cause an alert to be generate or an advisory message to be displayed on the user interface 205.

Another one of the example events that may be detected is a replay attack. The replay attack may be detected by identifying a pattern in the log data provided by the software agent 340 to the analytics engine. Such a pattern is defined according to rules held in the storage 410. Alternatively, the replay attack may be detected by applying a machine learning model to scores derived from the log data. The plurality of log data provided by the software agent 340 to the analytics engine and used to detect a replay attack includes log data identifying the time of receipt of different messages at the system 305 or the addresses (e.g. IP addresses) contained in those messages.

Another one of the example events that may be detected is a spoofing attack. The spoofing attack is an attack in which a person or program identifies as another by falsifying data. The analytics engine may detect a spoofing attack based upon log data comprising addressing information (e.g. an IP address) or based upon other information identifier a sender.

Further examples of events that may be detected and that are given in FIG. 9 include the opening of a door (i.e. a door of one of the devices 310), a decryption failure, a system restart, a bad password threshold, etc.

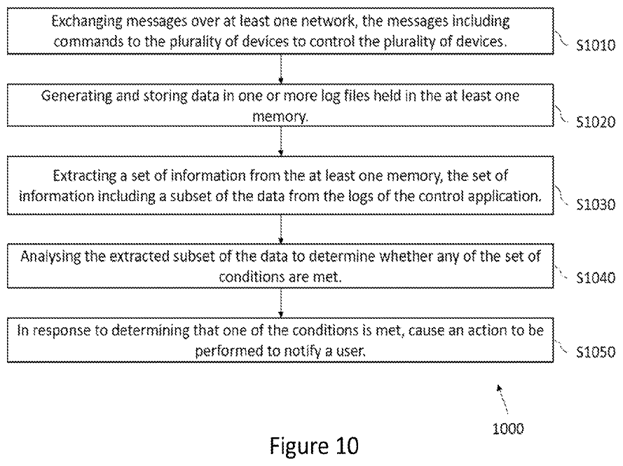

Reference is made to FIG. 10, which illustrates a method 1000 according to embodiments of the application.

At S1010, the control application 330 exchanges messages over at least one network. These messages include commands to the plurality of devices 310 to control those devices 310.

At S1020, the system 305 causes log data associated with the control application 330 to be generated and stored in one or more log files in the at least one memory. This log data is generated in dependence upon the messages exchanged over the at least one network 320 by the control application.

At S1030, the software agent 330 extracts a set of information from the at least one memory, the set of information including a subset of the data from the logs of the control application 330.

At S1040, the analytics engine 500 analyses the extracted subset of the data to determine whether any of the set of conditions are met.

At S1050, in response to determining that one of the conditions is met, the processor 405 causes an action to be performed to notify a user.

Implementations of the subject matter and the operations described in this specification can be realized in digital electronic circuitry, or in computer software, firmware, or hardware, including the structures disclosed in this specification and their structural equivalents, or in combinations of one or more of them. For instance, hardware may include processors, microprocessors, electronic circuitry, electronic components, integrated circuits, etc. Implementations of the subject matter described in this specification can be realized using one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

While certain arrangements have been described, the arrangements have been presented by way of example only, and are not intended to limit the scope of protection. The inventive concepts described herein may be implemented in a variety of other forms. In addition, various omissions, substitutions and changes to the specific implementations described herein may be made without departing from the scope of protection defined in the following claims.

### Annex A

A.1 A computer system comprising at least one processor and at least one memory, the at least one memory storing computer readable instructions, one or more log files, and a set of conditions, the at least one processor being configured to execute the instructions to:
provide a control application configured to exchange messages over at least one network, the messages including commands to a plurality of devices to control the plurality of devices;
generate and store log data for the control application in the one or more log files held in the at least one memory, where the log data is generated in dependence upon the messages exchanged over the at least one network by the control application;
provide a software agent configured to extract a set of information from the at least one memory, the set of information including a subset of the log data from the one or more log files;
provide an analytics engine configured to analyse the extracted subset of the log data to determine whether any of the conditions are met; and
in response to determining that one of the conditions is met, cause an action to be performed to notify a user.
A.2 A computer system as in paragraph A.1, wherein the set of information further comprises configuration data extracted from a configuration file stored in the at least one memory, wherein the analytics engine is further configured to determine whether any of the set of conditions are met by analysing the configuration data.
A.3 A computer system as in paragraph A.2, wherein the analytics engine is configured to determine that the one of the conditions is met in response to identifying a pattern or signature in the extracted subset of the log data and the configuration data.
A.4 A computer system as in any of paragraphs A.1 to A.3, wherein the step of analysing the extracted subset of the log data comprises:
in dependence upon the extracted subset of the log data, providing a plurality of input values to one or more machine learning modes configured to obtain an output; and
comparing the output to a threshold indicated by the one of the conditions to determine that the one of the conditions is met.
A.5 A computer system as in paragraph A.4, the at least one processor is configured to execute the instructions to:
generate from the extracted subset of the log data, the plurality of input values.
A.6 A computer system as in paragraph A.4 or paragraph A.5, wherein the set of information further comprises configuration data extracted from a configuration file stored in the at least one memory,
wherein the analytics engine is further configured to determine whether any of the set of conditions are met by analysing the configuration data,
wherein the at least one processor is configured to execute the instructions to in dependence upon the configuration data, provide a plurality of further input values to the one or more machine learning modes configured to obtain the output.
A.7 A computer system as in any of paragraphs A.4 to A.6, wherein the one or more machine learning models comprise a neural network configured to receive the input values.
A.8 A computer system as in any of paragraphs A.1 to A.7, wherein the step of analysing the extracted subset of the log data comprises:
identifying a pattern or signature in the extracted subset of the log data specified by the one of the set of conditions to determine that the one of the conditions is met.
A.9 A computer as in any of paragraphs A.1 to A.8, wherein the action comprises controlling the user interface to display statistical information relating to the at least one condition.
A.10 A computer system as in any of paragraphs A.1 to A.9, wherein the plurality of devices comprises a plurality of smart meters, wherein the computer system comprises a head end system that provides the control application.
A.11 A computer system as in any of paragraphs A.1 to A.10, wherein the action comprises generating an alert.
A.12 A computer system as in any of paragraphs A.1 to A.11, comprising a first computing device and a second computing device, wherein:
the first computing device comprises a first processor of the at least one processor, the first processor being configured to execute a first set of the computer readable instructions to:
   provide the control application and the software agent; and
   cause the extracted set of the information to be sent over the at least one network to the second computing device; and
the second computing device comprises a second processor of the at least one processor configured to execute a second set of the computer readable instructions to provide the analytics engine.
A.13 A computer implemented method comprising:
providing a control application configured to exchange messages over at least one network, the messages including commands to a plurality of devices to control the plurality of devices;
generating and storing log data for the control application in one or more log files held in at least one memory, where the log data is generated in dependence upon the messages exchanged over the at least one network by the control application;
extracting a set of information from the at least one memory, the set of information including a subset of the log data from the one or more log files;
analysing the extracted subset of the log data to determine whether any of a set of conditions are met; and
in response to determining that one of the conditions is met, causing an action to be performed to notify a user.
A.14 A computer implemented method as in paragraph A.13, wherein the set of information further comprises configuration data extracted from a configuration file stored in the at least one memory, wherein the method comprises determining whether any of the set of conditions are met by analysing the configuration data.
A.15 A computer implemented method as in paragraph A.13 or A.14, comprising determining that the one of the conditions is met in response to identifying a pattern or signature in the extracted subset of the log data and the configuration data.
A.16 A computer implemented method as in any of paragraphs A. 13 to A. 15, wherein the step of analysing the extracted subset of the log data comprises:
in dependence upon the extracted subset of the log data, providing a plurality of input values to one or more machine learning modes configured to obtain an output; and
comparing the output to a threshold indicated by the one of the conditions to determine that the one of the conditions is met.
A.17 A computer implemented method as in paragraph A.16, the method comprising generating from the extracted subset of the log data, the plurality of input values.
A.18 A computer implemented method as in paragraph A.16 or paragraph A.17, wherein the set of information further comprises configuration data extracted from a configuration file stored in the at least one memory, wherein the method comprises:
determining whether any of the set of conditions are met by analysing the configuration data,
in dependence upon the configuration data, providing a plurality of further input values to the one or more machine learning modes configured to obtain the output.
A.19 A computer implemented method as in any of paragraphs A. 16 to A. 18, wherein the one or more machine learning models comprise a neural network configured to receive the input values.
A.20 A computer program comprising computer readable instructions, which when executed by at least one processor cause a method to be performed, the method comprising:
providing a control application configured to exchange messages over at least one network, the messages including commands to a plurality of devices to control the plurality of devices;
generating and storing log data for the control application in one or more log files held in at least one memory, where the log data is generated in dependence upon the messages exchanged over the at least one network by the control application;
extracting a set of information from the at least one memory, the set of information including a subset of the log data from the one or more log files;
analysing the extracted subset of the log data to determine whether any of a set of conditions are met; and
in response to determining that one of the conditions is met, causing an action to be performed to notify a user.

1. A computer system comprising at least one processor and at least one memory, the at least one memory storing computer readable instructions, one or more log files, and a set of conditions, the at least one processor being configured to execute the instructions to:
provide a control application configured to exchange messages over at least one network, the messages including commands to a plurality of devices to control the plurality of devices;
generate and store log data for the control application in the one or more log files held in the at least one memory, where the log data is generated in dependence upon the messages exchanged over the at least one network by the control application;
provide a software agent configured to extract a set of information from the at least one memory, the set of information including a subset of the log data from the one or more log files;
provide an analytics engine configured to analyse the extracted subset of the log data to determine whether any of the conditions are met; and
in response to determining that one of the conditions is met, cause an action to be performed to notify a user.

2. A computer system as claimed in claim 1, wherein the set of information further comprises configuration data extracted from a configuration file stored in the at least one memory, wherein the analytics engine is further configured to determine whether any of the set of conditions are met by analysing the configuration data.

3. A computer system as claimed in claim 2, wherein the analytics engine is configured to determine that the one of the conditions is met in response to identifying a pattern or signature in the extracted subset of the log data and the configuration data.

4. A computer system as claimed in claim 1, wherein the step of analysing the extracted subset of the log data comprises:
in dependence upon the extracted subset of the log data, providing a plurality of input values to one or more machine learning modes configured to obtain an output; and
comparing the output to a threshold indicated by the one of the conditions to determine that the one of the conditions is met.

5. A computer system as claimed in claim 4, the at least one processor is configured to execute the instructions to:
generate from the extracted subset of the log data, the plurality of input values.

6. A computer system as claimed in claim 4, wherein the set of information further comprises configuration data extracted from a configuration file stored in the at least one memory,
wherein the analytics engine is further configured to determine whether any of the set of conditions are met by analysing the configuration data,
wherein the at least one processor is configured to execute the instructions to in dependence upon the configuration data, provide a plurality of further input values to the one or more machine learning modes configured to obtain the output.

7. A compute system as claimed in claim 4, wherein the one or more machine learning models comprise a neural network configured to receive the input values.

8. A computer system as claimed in claim 1, wherein the step of analysing the extracted subset of the log data comprises:
identifying a pattern or signature in the extracted subset of the log data specified by the one of the set of conditions to determine that the one of the conditions is met.

9. A computer as claimed in claim 1, wherein the action comprises controlling the user interface to display statistical information relating to the at least one condition.

10. A computer system as claimed in claim 1, wherein the plurality of devices comprises a plurality of smart meters, wherein the computer system comprises a head end system that provides the control application.

11. A computer system as claimed in claim 1, wherein the action comprises generating an alert.

12. A computer system as claimed in claim 1, comprising a first computing device and a second computing device, wherein:
the first computing device comprises a first processor of the at least one processor, the first processor being configured to execute a first set of the computer readable instructions to:
provide the control application and the software agent; and
cause the extracted set of the information to be sent over the at least one network to the second computing device; and
the second computing device comprises a second processor of the at least one processor configured to execute a second set of the computer readable instructions to provide the analytics engine.

13. A computer implemented method comprising:
providing a control application configured to exchange messages over at least one network, the messages including commands to a plurality of devices to control the plurality of devices;
generating and storing log data for the control application in one or more log files held in at least one memory, where the log data is generated in dependence upon the messages exchanged over the at least one network by the control application;
extracting a set of information from the at least one memory, the set of information including a subset of the log data from the one or more log files;
analysing the extracted subset of the log data to determine whether any of a set of conditions are met; and
in response to determining that one of the conditions is met, causing an action to be performed to notify a user.

14. A computer implemented method as claimed in claim 13, wherein the set of information further comprises configuration data extracted from a configuration file stored in the at least one memory, wherein the method comprises determining whether any of the set of conditions are met by analysing the configuration data.

15. A computer implemented method as claimed in claim 13, comprising determining that the one of the conditions is met in response to identifying a pattern or signature in the extracted subset of the log data and the configuration data.

16. A computer implemented method as claimed in claim 13, wherein the step of analysing the extracted subset of the log data comprises:
in dependence upon the extracted subset of the log data, providing a plurality of input values to one or more machine learning modes configured to obtain an output; and
comparing the output to a threshold indicated by the one of the conditions to determine that the one of the conditions is met.

17. A computer implemented method as claimed in claim 16, the method comprising generating from the extracted subset of the log data, the plurality of input values.

18. A computer implemented method as claimed in claim 16, wherein the set of information further comprises configuration data extracted from a configuration file stored in the at least one memory, wherein the method comprises:
determining whether any of the set of conditions are met by analysing the configuration data,
in dependence upon the configuration data, providing a plurality of further input values to the one or more machine learning modes configured to obtain the output.

19. A computer implemented method as claimed in claim 16, wherein the one or more machine learning models comprise a neural network configured to receive the input values.

20. A computer program comprising computer readable instructions, which when executed by at least one processor cause a method to be performed, the method comprising:
providing a control application configured to exchange messages over at least one network, the messages including commands to a plurality of devices to control the plurality of devices;
generating and storing log data for the control application in one or more log files held in at least one memory, where the log data is generated in dependence upon the messages exchanged over the at least one network by the control application;
extracting a set of information from the at least one memory, the set of information including a subset of the log data from the one or more log files;
analysing the extracted subset of the log data to determine whether any of a set of conditions are met; and
in response to determining that one of the conditions is met, causing an action to be performed to notify a user.
